(19) United States
(12) Patent Application Publication
(10) Pub. No.: US 2016/0204566 A1
(43) Pub. Date: Jul. 14, 2016

(54) GAS-DISCHARGE LASER POWER AND ENERGY CONTROL

(71) Applicant: Coherent, Inc., Santa Clara, CA (US)

(72) Inventors: Alan H. FIELD, Essex, CT (US); David ALLIE, Storrs, CT (US)

(21) Appl. No.: 14/987,473

(22) Filed: Jan. 4, 2016

Related U.S. Application Data
(60) Provisional application No. 62/143,738, filed on Apr. 6, 2015.
(60) Provisional application No. 62/101,950, filed on Jan. 9, 2015.

(51) Int. Cl. H01S 3/097; H01S 3/00

(52) U.S. Cl. CPC H01S 3/09702; H01S 3/0014

(57) ABSTRACT

The present disclosure is directed to simultaneously controlling peak pulse power and pulse energy in gas-discharge lasers. In an aspect, a radio-frequency power supply that is coupled to a gas-discharge laser is turned ON to initiate delivery of a laser pulse. The radio-frequency power supply is modulated ON/OFF to maintain the amplitude of the laser pulse at about a desired or prescribed value. Further, the radio-frequency power supply is turned OFF to terminate delivery of the laser pulse when the accumulated energy reaches reached a predefined energy threshold value.

### CROSS-REFERENCE TO RELATED APPLICATIONS

This application claims priority to U.S. Prov. Pat. App. Ser. No. 62/101,950, filed Jan. 9, 2015 and entitled CONTROL OF PEAK PULSE-POWER AND PULSE-ENERGY IN A GAS-DISCHARGE LASER, the entirety of which is hereby incorporated by reference for all intents and purposes. This application also claims priority to U.S. Prov. Pat. App. Ser. No. 62/143,738, filed Apr. 6, 2015 and entitled CO2 LASER POWER AND ENERGY CONTROL, the entirety of which is hereby incorporated by reference for all intents and purposes.

### BACKGROUND

Pulsed gas-discharge lasers are used for a number of exacting laser-machining applications, such as drilling via holes in printed circuit boards and engraving patterns in various materials for example. In such systems, a radio-frequency (RF) power supply is used to energize a lasing-gas mixture in order to generate laser light. A typical lasing-gas mixture includes helium (He), nitrogen (N₂) and CO₂ in proportions of about 80:10:10. The RF power supply can be pulsed so that the laser generates a series of individual laser pulses. The RF power supply can also be modulated during an individual laser pulse to control the laser pulse characteristics. Laser pulse-to-pulse inconsistency may be an issue in trains of laser pulses because of gas temperature transients, gas aging, cavity-tuning, etc. The inconsistencies may result in individual laser pulses in a laser pulse train (or the laser pulse train itself) having one or more parameters unsuitable for a particular machining operation.

### SUMMARY

The present disclosure is directed to simultaneously controlling peak pulse power and pulse energy in gas-discharge lasers.

In an embodiment, a gas-discharge laser system comprises: a gas-discharge laser; a RF power supply coupled to the gas-discharge laser and configured to energize the gas-discharge laser based on a drive signal; a detector configured to sample a laser pulse output by the gas-discharge laser and generate a detection signal representative of the instantaneous power of the laser pulse; a beam-splitter configured to supply a sample of the laser pulse to the detector; and a controller coupled to the detector. In an embodiment, the controller comprises: an energy control circuit configured to monitor accumulated energy of the laser pulse as output by the gas-discharge laser and based on the detection signal, the energy control circuit configured to output an energy signal to indicate when accumulated energy of the laser pulse has reached an energy threshold; a power control circuit configured to output a modulation signal based on a target instantaneous power for the laser pulse and the detection signal; and a drive control circuit coupled to the energy control circuit and the power control circuit, the drive control circuit configured to output the drive signal, wherein the drive control circuit is configured to modulate the drive signal based on the modulation signal when the energy signal indicates that accumulated energy is less than the energy threshold and turn off the drive signal when the energy signal indicates that accumulated energy is greater than the energy threshold.

In an embodiment, a controller for a laser comprises: an energy control circuit configured to monitor accumulated energy of a laser pulse as output by the laser and based on a detection signal representative of instantaneous power for the laser pulse, the energy control circuit configured to output an energy signal to indicate when accumulated energy of the laser pulse has reached an energy threshold; a power control circuit configured to output a modulation signal based on a target instantaneous power for the laser pulse and the detection signal; and a drive control circuit coupled to the energy control circuit and the power control circuit, the drive control circuit configured to output a drive signal for the laser, wherein the drive control circuit is configured to modulate the drive signal based on the modulation signal when the energy signal indicates that accumulated energy is less than the energy threshold and turn off the drive signal when the energy signal indicates that accumulated energy has reached the energy threshold.

In an embodiment, a method for operating a gas-discharge laser comprises: detecting a command to initiate output of a laser pulse by the gas-discharge laser; in response to detecting the command, supplying a signal to the gas-discharge laser to initiate output of the laser pulse by the gas-discharge laser; monitoring accumulated pulse energy of the laser pulse as output by the gas-discharge laser; during the monitoring, modulating the signal supplied to the gas-discharge laser based on a target instantaneous pulse power for the laser pulse; and terminating the signal supplied to the gas-discharge laser in response to determining that accumulated pulse energy of the laser pulse as output by the gas-discharge laser has reached an energy threshold value.

Other embodiments are possible.

### BRIEF DESCRIPTION OF THE DRAWINGS

FIG. 1 is a diagram of an example gas-discharge laser apparatus.

FIG. 2 is a diagram of a first embodiment of a controller circuit of FIG. 1.

FIG. 3 is a plot of a modulation signal output by the circuit of FIG. 2, and a plot of a voltage signal output by a detector of FIG. 1.

FIG. 4 is a plot of the open-loop and closed-loop response of the apparatus of FIG. 1.

FIG. 5 is a diagram of a second embodiment of a controller circuit of FIG. 1.

FIG. 6 is a diagram of a third embodiment of a controller circuit of FIG. 1.

FIG. 7A is a plot of a first demonstrative simulation according to the disclosure.

FIG. 7B is a plot of a second demonstrative simulation according to the disclosure.

FIG. 8 is a diagram of a fourth embodiment of a controller circuit of FIG. 1.

FIG. 9 is a diagram of an example command signal circuit of the circuit of FIG. 8.

FIG. 10 is a plot of a third demonstrative simulation according to the disclosure.

FIG. 11 is a diagram of an example pulse-width modulator of the circuit of FIG. 8.

FIG. 12 is a diagram of sequential operation of the circuit of FIG. 11.

FIG. 13 is a plot of a fourth demonstrative simulation according to the disclosure.

FIG. 14 is a diagram of a modification to a portion of the circuit of FIG. 11.

FIG. 15 is a plot of a fifth demonstrative simulation according to the disclosure.

FIG. 16A is a first plot of the gas-dependent response of the apparatus of FIG. 1.

FIG. 16B is a second plot of the gas-dependent response of the apparatus of FIG. 1.

FIG. 17 is a diagram of an example pulse parameters circuit of the circuit of FIG. 6.

### DETAILED DESCRIPTION

Pulsed gas-discharge lasers are used for a number of exacting laser-machining applications, such as drilling via holes in printed circuit boards and engraving patterns in various materials for example. Conventional pulse-parameter monitoring and control arrangements for such lasers may not be sufficient to prevent laser pulse-to-pulse inconsistencies that may result from pulse-to-pulse gas temperature transients, gas aging, cavity-tuning, and etc. Laser pulse inconsistencies may result in individual laser pulses in a laser pulse train or the laser pulse train itself having one or more parameters unsuitable for a particular machining operation. To address this and other issues, a control scheme is contemplated whereby peak pulse power and pulse energy are simultaneously monitored during the delivery of a laser pulse. An appreciation of the benefits and/or advantages of such an implementation may be gained from the following discussion in connection with the drawings.

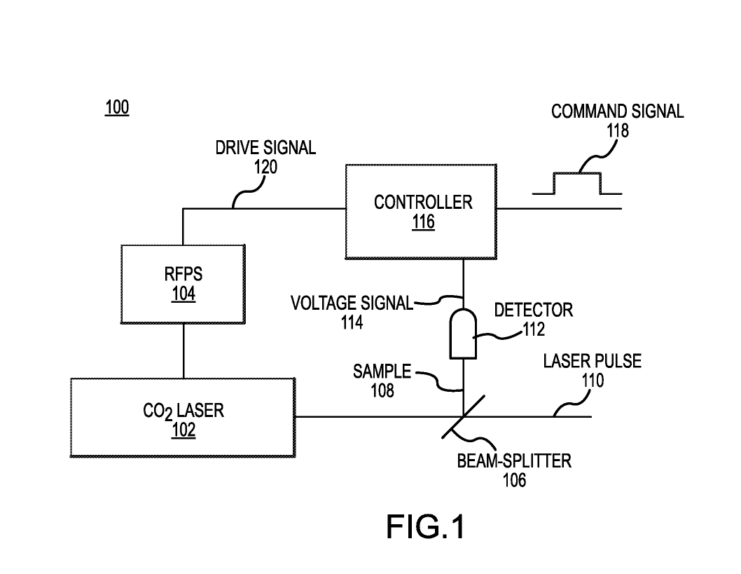

FIG. 1 is a block diagram of an example gas-discharge laser apparatus 100 according to the disclosure. In practice, a carbon dioxide gas-discharge laser (CO₂ laser) 102 is pulse-energized by a radio-frequency power supply (RFPS) 104, and a beam-splitter 106 directs (a reflected or transmitted beam from a beam splitter can optionally be used) a sample 108 of a laser pulse 110 that is output by the CO₂ laser 102 to a detector 112. The detector 112 provides a voltage signal 114 that is representative of instant or instantaneous pulse power of the laser pulse 110 to a controller circuit 116. The controller circuit 116 is responsive to a command signal 118 that represents requested delivery of the laser pulse 110. In general, the laser pulse 110 may be “requested” as part of a manual or automated process, such as when the laser pulse 110 is explicitly commanded by an end-user or when the laser pulse 110 is commanded by the apparatus 100 as part of a predefined routine or algorithm.

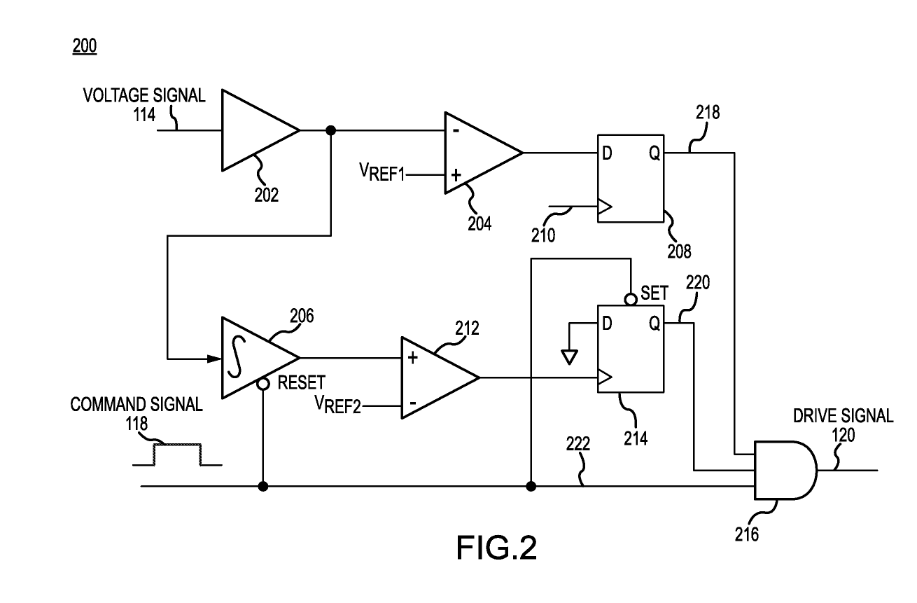

The controller circuit 116 is also responsive to the voltage signal 114. More specifically, upon detection of a leading edge of the command signal 118, and while the command signal 118 is digital-high for example, the controller circuit 116 outputs a drive signal 120 to amplitude modulate the RFPS 104, for example turn the RFPS 104 ON and OFF, and by extension the controller circuit 116 controls or maintains peak pulse power of the laser pulse 110 at about a desired or prescribed peak power value during delivery of the laser pulse 110. As discussed in detail below, the drive signal 120 output by the controller circuit 116 has a form that is a function of the voltage signal 114. Further, the controller circuit 116 integrates the voltage signal 114 over time to determine or derive in real-time a running total of the amount of energy delivered by the laser pulse 110, referred to as accumulated energy. The controller circuit 116 terminates delivery of the laser pulse 110, or equivalently ceases to modulate the RFPS 104, when the accumulated energy delivered by the laser pulse 110 reaches a predetermined or predefined energy threshold value. A first embodiment of the controller circuit 116 of the apparatus 100 of FIG. 1 is discussed in connection with FIG. 2.

FIG. 2 is a circuit diagram of a first embodiment 200 of the controller circuit 116 of the apparatus 100 of FIG. 1. In practice, the voltage signal 114 that is output by the detector 112 (see FIG. 1) is provided as input to a pre-amplifier 202, and the output of the pre-amplifier 202 is provided as input to both a first comparator 204 and an integrator 206. The output of the first comparator 204 is provided as input to a first flip-flop 208, and the first flip-flop 208 is driven at high-frequency by a clock signal 210, such as at 1 MHz, or 16 MHz, or 48 MHz for example. The output of the integrator 206 is provided as input to a second comparator 212, and the output of the second comparator 212 is provided as input to a second flip-flop 214. The output of each one of the first flip-flop 208 and the second flip-flop 214 is provided as input to a three-input AND gate 216. Other embodiments are possible. For example, the AND gate 216 may be realized as a NAND gate, or any suitable or implementation-specific combination of digital logic as would be understood by one of skill in the art. The command signal 118 too is provided as input to the AND gate 216, as well as input to both the integrator 206 and the second flip-flop 214.

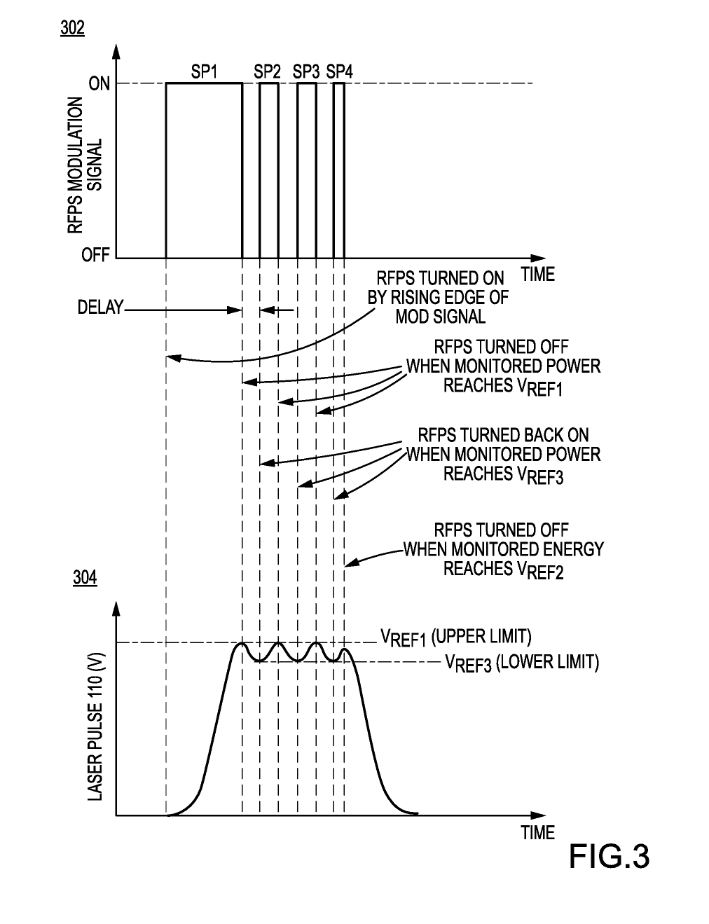

The AND gate 216 outputs the drive signal 120 to the RFPS 104 (see FIG. 1) only when all inputs to the AND gate 216 are in the same digital state (e.g., digital-high). A first input 218 to the AND gate 216 is digital-high, for example, when the output of the pre-amplifier 202 is less than a reference voltage V_{REF1} that is provided as input to the first comparator 204. The reference voltage V_{REF1} may be considered a set-point representative of a target instantaneous power or an upper limit instantaneous power value, and may be selected or defined as desired on a pulse-by-pulse basis. As discussed in detail below, the signal path including the pre-amplifier 202, the first comparator 204, and the first flip-flop 208 corresponds to a peak pulse power control branch or circuit of the controller circuit 116, equivalently, a power control circuit that in some embodiments may include or comprise one or more other elements or components of the controller circuit 116. A second input 220 to the AND gate 216 is digital-high, for example, when the output of the integrator 206 is less than a reference voltage V_{REF2} that is provided as input to the second comparator 212. The reference voltage V_{REF2} may be considered a set-point representative of an energy threshold value, and may be selected or defined as desired on a pulse-by-pulse basis. As discussed in detail below, the signal path including the pre-amplifier 202, the integrator 206, the second comparator 212, and the second flip-flop 214 corresponds to a pulse energy control branch or circuit of the controller circuit 116, equivalently, an energy control circuit that in some embodiments may include or comprise one or more other elements or components of the of the controller circuit 116. A third input 222 to the AND gate 216, equivalently, a drive control circuit that that in some embodiments may include or comprise one or more other elements or components of the controller circuit 116, is digital-high when the command signal 118 too is digital-high. Referring now additionally to FIG. 3, operation of the apparatus 100 of FIG. 1, and in particular the controller circuit 116 of the apparatus 100 of FIG. 1, is described in detail.

FIG. 3 is a plot 302 of a modulation signal that is output by the controller circuit 116 of the apparatus 100 of FIG. 1, and is a plot 304 of the voltage signal 114 that is output by the detector 112 of the apparatus 100 of FIG. 1. In practice, the command signal 118 (see FIGS. 1-2) is initially digital-low, the integrator 206 is cleared, and the output of the second flip-flop 214 is set to digital-high. At the leading or rising edge of command signal 118, the integrator 206 is released, all inputs to the AND gate 216 are at digital-high, and the RFPS 104 is turned ON by the drive signal 120. Soon after the RFPS 104 is turned ON, instantaneous pulse power of the laser pulse 110 begins to increase or rise, and the detector 112 outputs the voltage signal 114 that is representative of instant or instantaneous power of the laser pulse 110 to the controller circuit 116 as mentioned above in connection with FIG. 1.

When instantaneous pulse power of laser pulse 110 is such that the voltage signal 114 reaches V_{REF1} following the initial energization of the CO₂ laser 102 (see FIG. 3), the output of the first comparator 204 is set to digital-low, the output of the first flip-flop 208 is set to digital-low at a next or subsequent cycle of the clock signal 210, the RFPS 104 is turned OFF, and instantaneous pulse power of the laser pulse 110 begins to decrease or fall. When instantaneous pulse power of laser pulse 110 is such that the voltage signal 114 drops below V_{REF1}, the output of the first comparator 204 is set to digital-high, the output of the first flip-flop 208 is set to digital-high at a next or subsequent cycle of the clock signal 210, and the RFPS 104 is turned back ON. Optionally, the first comparator 204 may have a hysteresis that allows voltage signal 114 to drop some offset below V_{REF1} before the output of the first flip-flop 208 is set to digital-high at a next or subsequent cycle of the clock signal 210, and the RFPS 104 is turned back ON.

Next, when instantaneous pulse power of laser pulse 110 is such that the voltage signal 114 again reaches V_{REF1}, the RFPS 104 is again turned OFF, and so on as modulation of the RFPS 104 continues in time. The modulation of the RFPS 104 however does not occur indefinitely. Specifically, during the modulation of the RFPS 104, the energy in or of the laser pulse 110 is determined or quantified by the integrator 206, and is provided as input to the second comparator 212 (see FIG. 2). When accumulated energy in or of laser pulse 110 reaches V_{REF2}, the output of the second comparator 212 is set to digital-high, causing a digital-low to be clocked at the output of the second flip-flop 214. This results in termination of the laser pulse 110 because the second input 220 to the AND gate 216 is then no longer digital-high (i.e., all inputs to the AND gate 216 no longer exhibit the same digital state). Delivery of a subsequent laser pulse cannot occur until the command signal 118 first goes digital-low. This clears the integrator 206 and sets the output of the second flip-flop 214 back to digital-high. When the command signal 118 again goes digital-high, another laser pulse may be initiated and output by the apparatus 100, and the RFPS 104 is modulated in a manner as discussed with reference to the laser pulse 110.

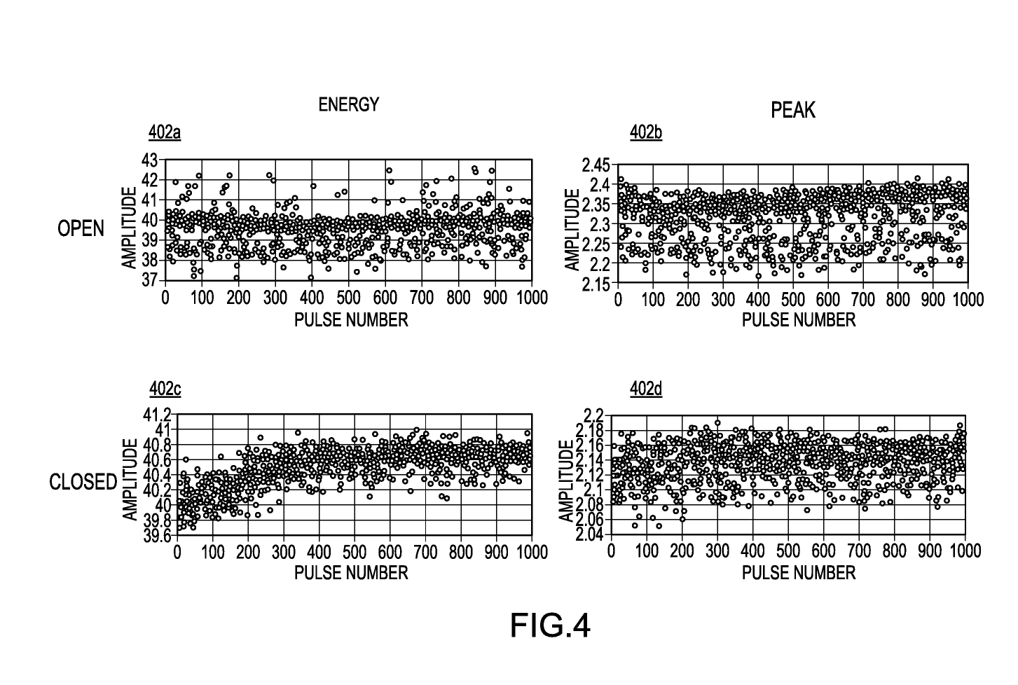

FIG. 3 depicts an example modulation scheme for the RFPS 104 of FIG. 1 and a representation of the laser pulse 110 produced by the example modulation scheme. Plot 302 depicts four modulation signal sub-pulses SP1, SP2, SP3 and SP4. Plot 304 depicts the laser pulse 110 in terms of the detected instantaneous laser pulse power as measured by a detector (for example, the voltage signal 114 produced by the detector 112). Sub-pulse SP1 of plot 302 has the longest duration as it takes a finite amount of time for the instantaneous pulse power of the laser pulse 110 to rise from zero such that the voltage signal 114 reaches V_{REF1}. Sub-pulses SP2, SP3, and SP4 are of shorter duration than SP1, as the rise to V_{REF1} starts not from zero but roughly from a lower voltage limit, that may be referred to as V_{REF3} as indicated in plot 304. The lower voltage limit V_{REF3} may be considered a set-point and may be selected or defined as desired on a pulse-by-pulse basis. However, in some embodiments, the lower voltage limit V_{REF3} may be a function of the hysteresis of the first comparator 204 and/or the frequency of the clock signal 210. In practice, the controller circuit 116 generally maintains instantaneous pulse power of the laser pulse 110 between about V_{REF1} and V_{REF3} after the instantaneous pulse power of laser pulse 110 initially reaches V_{REF1} and while the accumulated energy of the laser pulse 110 is less than or equal to a predetermined or predefined energy threshold value. Notably, sub-pulses SP1-SP3 are initiated and terminated by the peak pulse power control branch or circuit of the controller circuit 116, and sub-pulses SP2 and SP3 have about the same duration. Sub-pulse SP4 is of shorter duration than sub-pulses SP2 and SP3, and is initiated by the peak pulse power control branch or circuit of the controller circuit 116, but is terminated by the pulse energy control branch or circuit of the controller circuit 116. The simultaneous control of peak pulse power and pulse energy as discussed throughout in connection with the controller circuit 116 as shown in FIG. 1 is beneficial and/or advantageous in many respects. Pulse-to-pulse uniformity is but one example. This is illustrated in FIG. 4.

FIG. 4 shows a number of plots of the open-loop and closed-loop response of the apparatus 100 of FIG. 1. In particular, plot 402a in FIG. 4 shows the variation in pulse energy delivered by the apparatus 100 of FIG. 1, and plot 402b shows the variation in peak pulse power delivered by the apparatus 100 of FIG. 1, on a pulse-to-pulse basis for 1000 command signal (e.g., command signal 118) pulses of fixed pulse width but randomly varied pulse period. The results shown in plot 402a and plot 402b may be referred to as the open-loop response of the apparatus 100 of FIG. 1. In contrast, plot 402c in FIG. 4 shows the variation in total energy delivered by the apparatus 100 of FIG. 1, and plot 402d shows the variation in peak pulse power delivered by the apparatus 100 of FIG. 1, on a pulse-to-pulse basis for 1000 laser pulses with both the peak pulse power and the pulse energy of each of the respective pulses being monitored and controlled. In other words, both the peak pulse power control branch or circuit of the controller circuit 116 and the pulse energy control branch or circuit of the controller circuit 116 are leveraged during acquisition of the data as shown in plot 402c and plot 402d. The results shown in plot 402c and plot 402d may be referred to as the closed-loop response of the apparatus 100 of FIG. 1. One of skill in the art will appreciate that FIG. 4 illustrates the effectiveness and benefits and/or advantages of simultaneous control of peak pulse power and pulse energy as discussed throughout in connection with the controller circuit 116 as shown in FIG. 1.

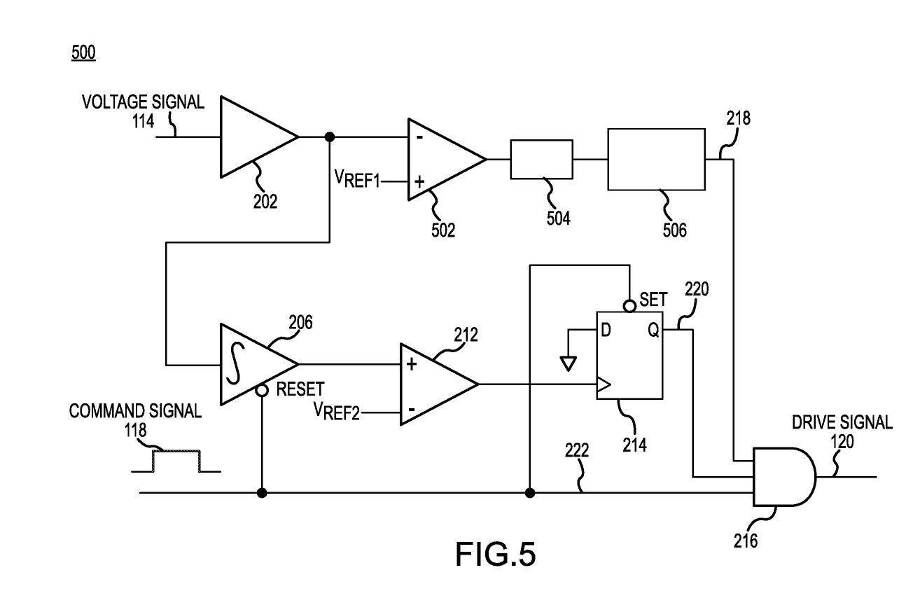

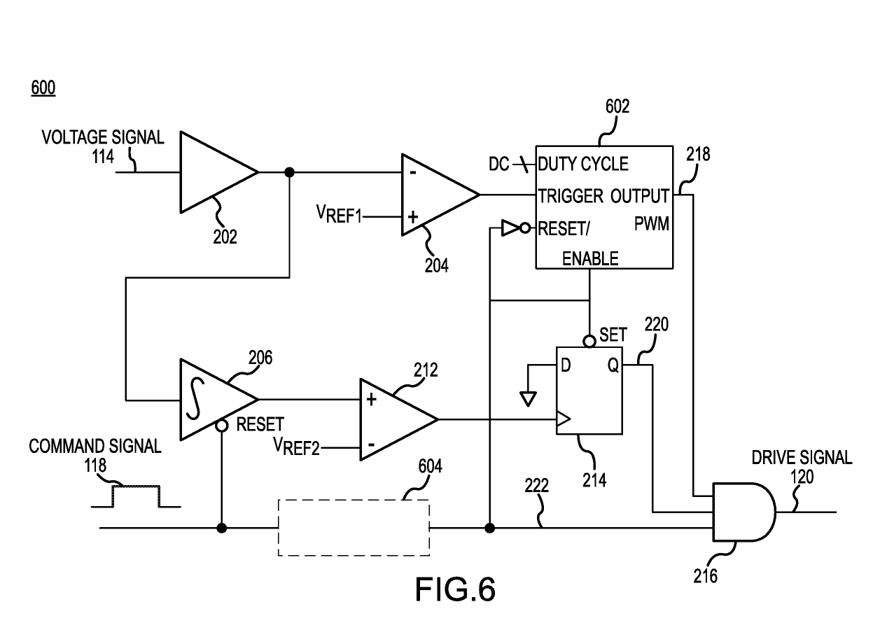

Specifically, in an arrangement with only peak pulse power and pulse energy being monitored but not controlled (see plots 402a-b), pulse energy delivered by the uncontrolled laser varied by 14.6% (see plot 402a) and peak pulse power varied by 11.4% (see plot 402b) during delivery of 1000 pulses. In example embodiments, the mathematical expression 100%*(Maximum-Minimum)/Minimum is used to calculate variation. However, in an arrangement with both peak pulse power and pulse energy being monitored and controlled (see plots 402c-d), and using the identical command sequence pattern of fixed pulse width but randomly varied pulse period, pulse energy varied by 3.3% (see plot 402c) and peak pulse power varied by 6.8% (see plot 402d) during delivery of 1000 pulses. In other words, pulse-to-pulse uniformity is vastly improved when both peak pulse power and pulse energy are monitored and controlled in a manner as discussed throughout. In the present example specifically, the variation in total energy delivered improved from 14.6% to 3.3% and the variation in peak pulse power improved from 11.4% to 6.8%. In tests where only pulse energy control or pulse peak control was used, it was found that although the controlled property uniformity could be improved by amounts similar to those above, the property which was not controlled was made worse in comparison to uniformity when neither property was controlled. Superior reduction or minimization of peak pulse power fluctuation is achieved by replacing the flip-flop modulator in the peak pulse power control branch of the circuit arrangement of FIG. 2 with a pulse-width modulator (PWM) circuit. Examples of such an implementation are discussed in connection with FIG. 5 and FIG. 6.

FIG. 5 is a circuit diagram of a second embodiment 500 of the controller circuit 116 of FIG. 1. The architecture of the controller circuit 116 as shown in FIG. 5 is in general similar to the architecture of the controller circuit 116 as shown in FIG. 2, and by extension the functionality of the controller circuit 116 as shown in FIG. 5 is in general similar to the functionality of the controller circuit 116 as shown in FIG. 2. However, the first comparator 204 as shown in FIG. 2 is replaced by a differential amplifier 502 as shown in FIG. 5, and the first flip-flop 208 as shown in FIG. 2 is replaced by a precision rectifier 504 and a PWM circuit 506 as shown in FIG. 5. In practice, the PWM circuit 506 maintains peak pulse power of the laser at about a power corresponding to the reference voltage V_{REF1} while pulse energy of the laser is monitored and controlled as previously described. More specifically, the voltage-controlled PWM circuit 506 functions by modulating the RFPS 104 to deliver sub-pulses that are varied in duration or duty cycle to maintain peak pulse power of the laser output pulse at about a power corresponding to the detector 112 output voltage of about V_{REF1}. Still other embodiments are possible.

Specifically, the instantaneous pulse power control branch or circuit of the controller circuit 116 as shown and described above in connection with FIG. 5 (and FIG. 2) may be generalized and expanded to provide a plurality of operational modes. In particular, in addition to using a modulated pulse duty cycle to control laser output pulse amplitude while simultaneously using an integrator to control pulse energy on a pulse-to-pulse basis, additional operational modes apply to how the duty cycle modulator is constructed and used in manners that improve and expand on the above-described means for controlling instantaneous laser pulse amplitude and energy simultaneously. The operating modes of the modulation data path, or equivalently the peak pulse power control branch or circuit of the controller together with the pulse energy control branch or circuit of the controller, can be selected and configured by a non-complex command language, on-the-fly, during operation of the apparatus 100 of FIG. 1. An example of such an implementation is discussed in connection with FIG. 6.

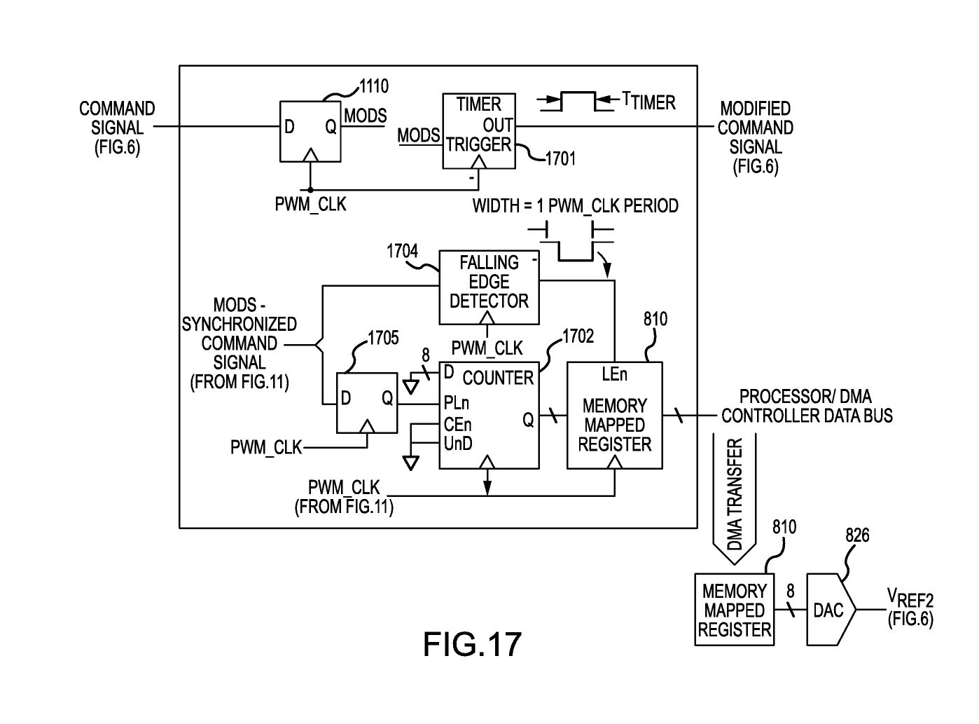

FIG. 6 is a circuit diagram of a third embodiment 600 of the controller circuit 116 of FIG. 1. The architecture of the controller circuit 116 as shown in FIG. 6 is in general similar to the architecture of the controller circuit 116 as shown in FIG. 2, and by extension the functionality of the controller circuit 116 as shown in FIG. 6 is in general similar to the functionality of the controller circuit 116 as shown in FIG. 2. However, the first flip-flop 208 as shown in FIG. 2 is replaced by a PWM circuit 602 as shown in FIG. 6, and a pulse parameters circuit 604 is optionally included (indicated by intermittent line in FIG. 6) along the signal path that includes the command signal 118. In general, the pulse parameters circuit 604 provides a means for the operator to communicate a target value pulse-by-pulse for one or more pulse parameters by encoding the target value into the command signal (e.g., command signal 118). Further it can provide alternate means of detecting and notifying an operator or technician of degradations of the CO₂ laser 102 due to aging and other mechanisms. An example implementation of the pulse parameters circuit 604 is discussed in connection with FIG. 17.

In practice, the circuit as shown in FIG. 6 uses an optimum, initial PWM duty cycle for any desired pulse power value by using a predetermined value in a PWM duty cycle compare register. This optimal, initial PWM duty cycle determines the sub-pulse duty cycle immediately following the first crossing of the V_{REF1} threshold by the output of the pre-amplifier 202 of FIG. 2. This duty cycle value can optionally be maintained throughout the duration of the laser output pulse or alternatively continuously adjusted using output of the first comparator 204 throughout the duration of the laser output pulse. The principle by which the optimum, initial duty cycle can be correctly determined, and a circuit that realizes laser pulse control accordingly, may be understood by analogy to a less complex system, an RC low-pass circuit.

More specifically, the analogy uses the response of an RC low-pass circuit to square wave excitation in order to demonstrate how a system with an exponential response governed by a single time constant, such as an RF pulse-pumped CO₂ laser (e.g., CO₂ laser 102) can be forced into equilibrium immediately upon first reaching a desired state corresponding to a power set point value. In this analogy, the voltage at the input node of the RC circuit represents the RF amplitude delivered to the CO₂ laser, and the voltage at the R-C node represents to first order the output power of the CO₂ laser. The input node voltage waveform that is analogous to the driving function of the CO₂ laser is a fixed amplitude pulse waveform of arbitrary duty cycle. RF pump duty cycle is the independent variable that is used to control output power in traditional RF pulse-pumped CO₂ lasers.

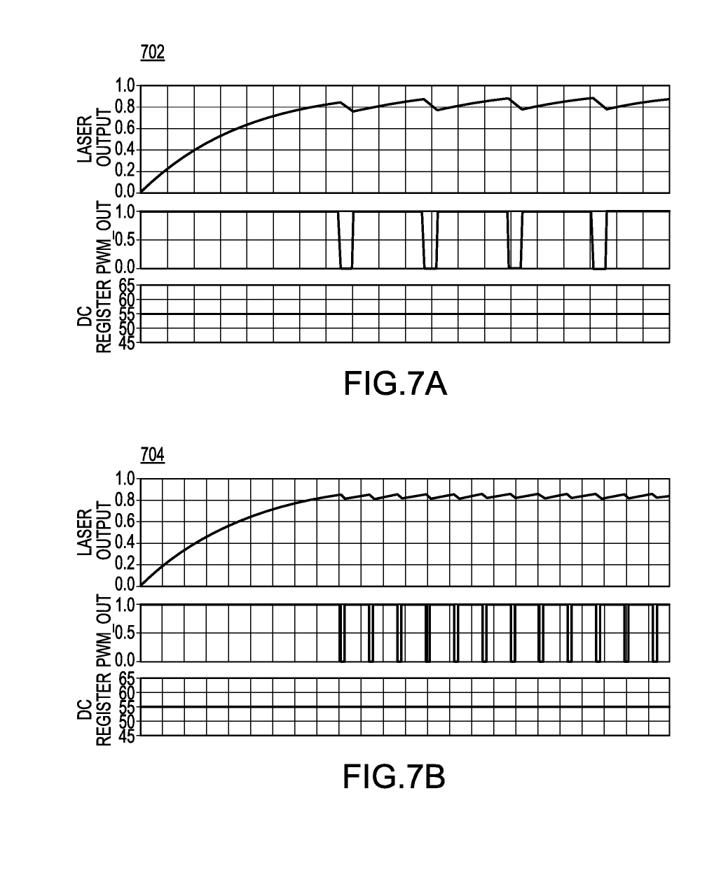

For further simplicity the amplitude of the input waveform can be normalized to one (unitary). With the input waveform amplitude normalized as such and a desired output voltage, V, at the R-C node, the required duty cycle of the input waveform is precisely V. By switching the duty cycle of the input waveform from 1 to V instantaneously at the moment that the desired output is reached, the RC low-pass circuit is instantaneously forced into an equilibrium state from which no further change in forcing function is required. This behavior is illustrated in the simulation plots of FIGS. 7A-B.

FIG. 7A is a plot 702 of a first demonstrative simulation according to the disclosure. FIG. 7B is a plot 704 of a second demonstrative simulation according to the disclosure. In these simulations, the response of an RF pulse-pumped CO₂ laser is modeled by Equation 1, with independent variable time starting from t=0 at the moment pumping starts or begins:

Laser Output=(1−e^{-t/τ}); τ=5 μs (1)

The total simulation time in plot 702 of FIG. 7A is 25 μs corresponding to an RF amplitude pulse width of 25 μs. Not shown is the decay, or fall time, response of the CO₂ laser when RF pumping is turned OFF. With additional reference to FIG. 1 and FIG. 6, the PWM_Out trace represents the output of the PWM circuit 602. PWM_Out is switched to a digital-low state thus turning OFF RF pumping of the CO₂ laser 102 by the RFPS 104 immediately after laser output reaches reference voltage V_{REF1} in a manner as discussed above. The falling edge on the output of the first comparator 204 is used by logic in the PWM circuit 602 to start the PWM cycle. The PWM circuit 602 is comprised of an UP counter of fixed period, a duty cycle or DC compare register, and a digital comparator. When the UP counter value equals the DC compare register value the PWM_Out signal is returned to digital-high until the end of the PWM counter period is reached, at which point the PWM period count cycle repeats starting from a next or subsequent clock cycle. The error between the desired laser output level and the actual laser output level is governed by the time constant (e.g. 5 μs) of the laser output pulse and the period of the modulation. For the simulation of FIG. 7A the peak-valley error, or ripple, in the Laser_Output signal, which represent the laser pulse 110, is 17%. The clock used in the simulation is 16 MHz and the PWM counter period is 64 counts resulting in a PWM Out signal frequency of 250 kHz. The ripple can be made arbitrarily low by increasing the PWM clock frequency. Equivalently, the instantaneous pulse power of the laser pulse 110 can be maintained within a percent threshold value of a target instantaneous pulse power, such as within +/−10% of the target instantaneous power for example. In this example, the controller circuit 116 would prevent instantaneous pulse power of the laser pulse 110 from reaching a value that is greater than +/−10% of the target instantaneous power. However, the controller circuit 116 would permit instantaneous pulse power of the laser pulse 110 to reach a particular value that is within the +/−10% range, such as a value of +/−8% of the target instantaneous power for instance. Other examples are possible. This is shown in FIG. 7B whereby the PWM_Out frequency is increased to 750 kHz, and ripple reduces from 17% to 5% when a 48 MHz clock frequency is used. In some embodiments, a preferred output or fundamental frequency of the clock (also referred to as PWM_CLK throughout) is between 250 kHz and 750 kHz inclusive. It is contemplated that a precise value of the output or fundamental frequency of the clock may be selected based on implementation-specific details and further may vary on a laser pulse to laser pulse basis.

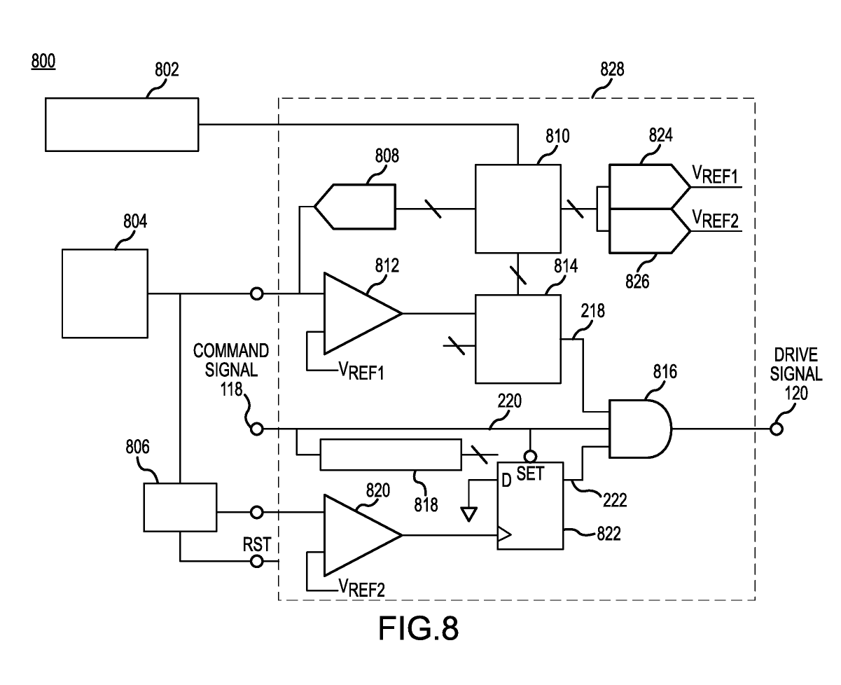

Because the scaling of the power controlling signal V_{REF1} and the PWM duty cycle control value, DC, can be different and because of manufacturing variances such as detector sensitivity and amplifier gain and offset, it is contemplated that a non-complex two-point calibration procedure may be used to determine the value of optimum DC value as a function of the desired output power. If absolute power calibration is also desired then a calibration procedure may be leveraged to teach the circuit the relationship P_{absolute}=k*V_{REF1}, whereby k is a constant integer value. The calibration procedure(s) may result in the calibration relations: V_{REF1}=k₁*P_{desired} and DC=k₂*V_{REF1}+k₃, whereby each one of k₁₋₃ is a constant integer value. However, it is contemplated that knowledge and maintenance of such calibration details are unnecessary complications for the laser machining tool designer and technician, as are keeping track of a complex instruction set and calibration equations. More specifically, such complexities and specialized knowledge retention have an adverse effect on productivity and costs in machine design, recipe or program development, and manufacturing operation of laser machining tools. The modulation data path expansion shown in FIG. 8 introduces additions to address this and other objects of the present disclosure.

FIG. 8 is a circuit diagram of a fourth embodiment 800 of the controller circuit 116 of FIG. 1. The architecture of the controller circuit 116 as shown in FIG. 8 is in general similar to the architecture of the controller circuit 116 as shown in FIG. 6, and by extension the functionality of the controller circuit 116 as shown in FIG. 8 is in general similar to the functionality of the controller circuit 116 as shown in FIG. 6. However, the fourth embodiment 800 of the controller circuit 116 includes a host computer interface 802, a pre-amplifier 804 (e.g., similar to the pre-amplifier 202 of FIG. 6), an integrator 806 (e.g., similar to the integrator 206 of FIG. 6), an analog-digital converter (ADC) 808, at least one microprocessor 810, a first comparator 812 (e.g., similar to the first comparator 204 of FIG. 6), a PWM circuit 814 (e.g., similar to the PWM circuit 602 of FIG. 6), a three-input AND gate 816 (e.g., similar to the AND gate 216 of FIG. 6), a command signal circuit 818, a second comparator 820 (e.g., similar to the second comparator 212 of FIG. 6), a flip-flop 822 (e.g., similar to the second flip-flop 214 of FIG. 6), a first digital-analog converter (DAC) 824, and a second DAC 826. As shown in FIG. 8, it is contemplated that a number of the respective components may be incorporated on or realized as a microcontroller or programmable system on-a-chip 828. Other embodiments are possible.

The microprocessor 810 and the host computer interface 802 as shown in FIG. 8 enable operation of the modulation data path of the controller circuit 116 as shown in FIG. 8, or equivalently the peak pulse power control branch or circuit of the controller circuit 116 together with the pulse energy control branch or circuit of the controller circuit 116, easily and automatically over a wide range of laser output power and in a plurality of operating modes to produce pulses of predetermined amplitude, energy, shape, and machine-controlled timing as will be explained in context below. Such additions, as well as additional peripheral devices or components, such as the ADC 808 shown in FIG. 8, can be readily made or acquired at low-cost using for example, programmable system-on-chip devices, such as the PSoC5LP available from Cypress Semiconductor. Although such an implementation-specific feature may evolve as technology evolves. Further, the ADC 808 is used for performance monitoring and preventive maintenance procedures. Such performance monitoring and procedures function as real-time laser power data acquisition with sequential pulse indexing and can greatly accelerate development time for new material process development because such performance monitoring and procedures enable correlation of a particular work piece result, such as the diameter and depth of a via hole measured by microscopy, with the properties of a particular laser pulse that was used to form the particular work piece result. In addition, on-going monitoring and recording of laser output properties, such as rise/fall times, peak pulse power and pulse energy, and comparing current values to past and/or reference values, can be used to determine when preventive maintenance procedures should be used to prevent an aging laser from causing unexpected machine downtime. Detailed descriptions of these additional operations are described in turn below.

Referring still to FIG. 8, the PWM circuit 814, DAC 824, and DAC 826 are controlled by memory-mapped control registers of the microprocessor 810. These registers include registers for setting and retaining the desired pulse power level via the reference signal V_{REF1} that is provided as input to the first comparator 812, the desired PWM duty cycle via the compare value presented to the PWM circuit 814, and the desired pulse energy value via the reference signal V_{REF2} that is provided as input to the second comparator 820. It is contemplated that the microprocessor command set includes commands such as a PXXX command and an EXXX command. In these examples, the “P” command specifies a desired or prescribed laser pulse power and the “E” command specifies a desired or prescribed laser pulse energy, each to 3 digits of precision for example. Upon receipt of these commands from the host computer interface 802, the microprocessor 810 converts the command values to digital register values and also uses a duty cycle calibration equation (e.g., V_{REF1}=k1*P_{desired}; DC=k₂*V_{REF1}+k₃) to write the appropriate duty cycle control value to the PWM compare register. From this point in time, the behavior of the modulation data path for each subsequent cycle of the command signal 118, hereinafter also referred to as “MOD_In” signal, is as explained above using the demonstrative simulation results of FIGS. 7A-B.

Further, it is contemplated that the leading edge of the MOD_In signal marks the time at which a laser pulse is to issue. The trailing edge of the MOD_In signal, however, does not need to be used to control pulse amplitude and energy as is done in traditional CO₂ lasers. Rather, the trailing edge of the MOD_In signal may be used to mark the maximum time at which the desired pulse energy or dose is expected to have been delivered to a work piece. Further, in a slightly modified operating mode whereby the microprocessor 810 is made aware of the instant or instantaneous state of the MOD_In signal, it is contemplated that the modulation data path can use the trailing edge of MOD_In signal to address other objects of the present disclosure, such as diagnostics and preventative maintenance. Due to aging effects the CO₂ laser 102 (see FIG. 1) may become less efficient over time, and also spurious effects can affect individual laser pulses. In such scenarios, the time required to deliver the desired pulse energy might become longer and eventually exceed the time allotted by the trailing edge of the MOD_In signal.

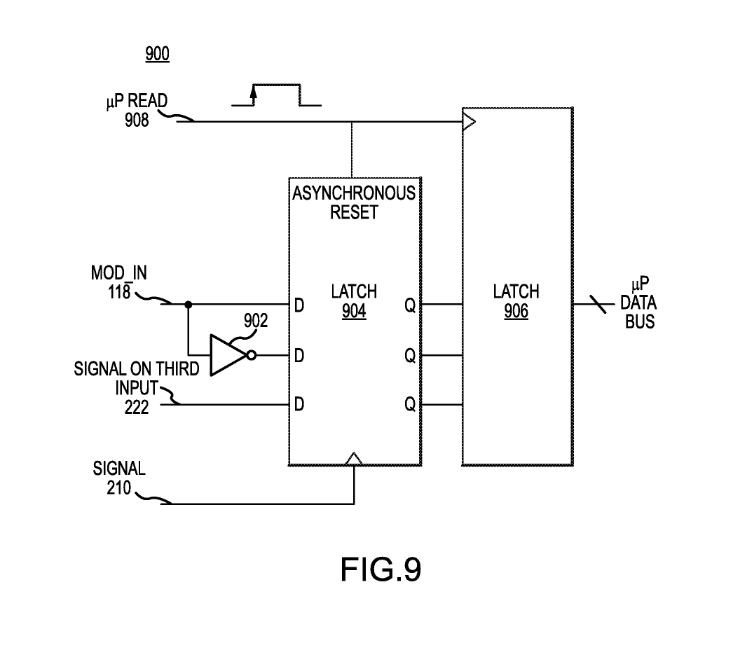

To implement this mode, it is contemplated that the command signal circuit 818 (see FIG. 8) may be used or leveraged to signal the microprocessor 810 when the trailing edge of the MOD_In signal occurs and the second comparator 820 has not yet triggered the flip-flop 822. FIG. 9 is a circuit diagram of an example embodiment 900 of the command signal circuit 818 shown in FIG. 8. The command signal circuit 818 includes an inverter 902, a first latch 904, and a second latch 906. A microprocessor read signal 908 is provided as input to both the first latch 904 and the second latch 906. The MOD_In signal, or equivalently the command signal 118 (see FIG. 1), is provided as input to both the first latch 904 and the inverter 902. In turn, the output of the inverter 902 is provided as input to the first latch 904. Further, the output of the flip-flop 822 and the PWM_CLK is provided as input to the first latch 904.

Methods for reading the state of asynchronous digital signals using a microprocessor leverage status registers and may include interrupt generation hardware triggered by status register state coupled with interrupt service routine software or status register polling software. It is contemplated that the example circuit shown in FIG. 9 may leverage such methods, and can for example be implemented using the status register component that is available in the PSoC5LP component library. For example, the first latch 904 and the second latch 906 as shown in FIG. 9 may be configured to generate interrupts on occurrence of digital-high states on any or none of the input signals as shown in FIG. 9 and hold the Q outputs fixed until a microprocessor read cycle resets the first latch 904 and passes the Q values to the bus. Details of using such a component can be found in its component data sheet which is included in the PSoC design software toolkit. It is contemplated that using a PSoC5LP status register or equivalent, together with logic as contemplated and shown in Table 1 below, the microprocessor 810 can determine when low-to-high and high-to-low transitions occur on the Mod_In signal, and by extension when potential fault conditions occur, such as the case when pulse energy delivered is not yet equal to the desired amount when a high-to-low transition occurs on the Mod In signal. An error signal may be generated and output by the microprocessor 810, or equivalently the controller circuit 116 of the present disclosure, in this situation or scenario.

In Table 1, Mod_In corresponds to the digital state of the command signal 118, Mod_In_Not corresponds to the inverted digital state of the command signal 118, FF_State corresponds to the signal on the third input 222 (see FIG. 1), the state of the flip-flop 822, and Microprocessor_Message corresponds to the determination made by the microprocessor 810 based on the data passed to the microprocessor 810 on the data bus as shown in FIG. 9. Other embodiments are possible.

TABLE 1

| Mod_In | Mod_In_Not | FF_State | Microprocessor_Message |
|---|---|---|---|
| 1 | 0 | 0 | Mod_In has gone true; RFPS |
| | | | 104 has begun pumping CO₂ |
| | | | laser 102 (see FIG. 1) |
| 0 | 1 | 0 | Mod_In has gone false; laser |
| | | | pulse 110 has |
| | | | terminated normally |
| 0 | 1 | 1 | The falling edge has occurred |
| | | | on Mod_In before the |
| | | | desired full energy dose |
| | | | was delivered by laser pulse |
| | | | 110 (an error signal |
| | | | may be generated/output) |

Additional operational modes are possible by making the microprocessor 810 aware of both leading and trailing edge transitions of the MOD_In signal. Traditionally, hole or via drilling in printed circuit boards is done by making a complete pass over an entire panel with the objective of delivering an identical CO₂ laser dose at all sites where a single hole size is desired. Multiple passes over the panel are required when more than one hole size is desired or when a given hole type or feature is best made using more than one dose at different dose levels and times. By preloading the memory of the microprocessor 810 with an array of pulse power and pulse energy values, and by using the microprocessor 810 to load corresponding values sequentially into the control registers each time the MOD_In signal makes a high-to-low transition, an arbitrary sequence or recipe, of laser pulses with precise power and energy values can be laid down by the apparatus 100 of FIG. 1. Advantageously, sequence change may be accomplished by downloading new arrays of sequential peak and energy values over the host computer interface 802. In practice, the microprocessor 810 counts the MOD_In signal transitions and uses the count as an index to step through the arrays sequentially. This sequence can repeat indefinitely in cases such as printed circuit board panel drilling. Printed circuit board panels contain several instances of the same printed circuit board and drilling holes in them amounts to cycling through the same pattern of hole locations several times in a step and repeat fashion, or, in raster scan-type machine designs, the pulse profile for each row can be downloaded or otherwise selected from memory prior to the start of each scan. In all types of machine design, the sequence of pulses ultimately can be translated into an array of sequential pulses that is repeated and such repetition can be managed by the microprocessor using arrays that represent desired pulse properties and means to count MOD_In signal transitions such that the count can be used as an index to the arrays. Such arrays can describe pulse power and pulse energy and other properties as well.

Further, the nature of an RF pulse-pumped CO₂ laser (e.g., CO₂ laser 102) can be characterized by additional, longer time constants and other models which account for effects such as the effect of gas and electrode temperature on pulse amplitude stability. These effects cause departures from the single-time-constant model explained by analogy above for longer pulse widths and for relatively long duration pulse streams. Laser-internal temperatures can go through large changes during long laser machining operations such as drilling via holes in a panel of printed circuit boards or making light scattering points in a flat panel display diffusion panel. The effect of increased temperature is to reduce the efficiency of the laser and less output power is delivered for a given RF duty cycle. A generalized model for such effects is given by Equation 2. In Equation 2, the collection of thermal or temperature effects are represented by a product of functions on Tₙ that model the temperatures of the gas, electrodes, and other components of the apparatus 100 of FIG. 1:

$$Laser Output = ( 1 - {e}^{- t / τ} ) {\prod }_{0}^{n} f ( {T}_{n} ) \qquad ( 2 )$$

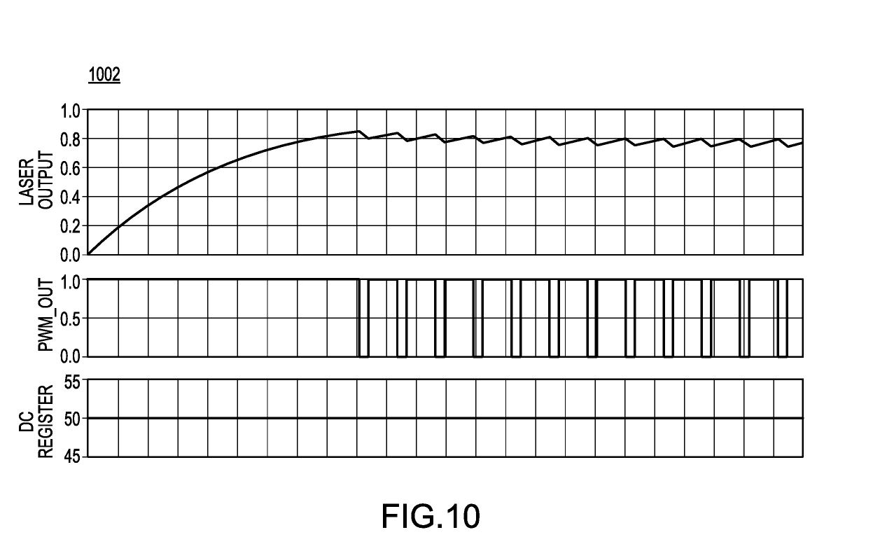

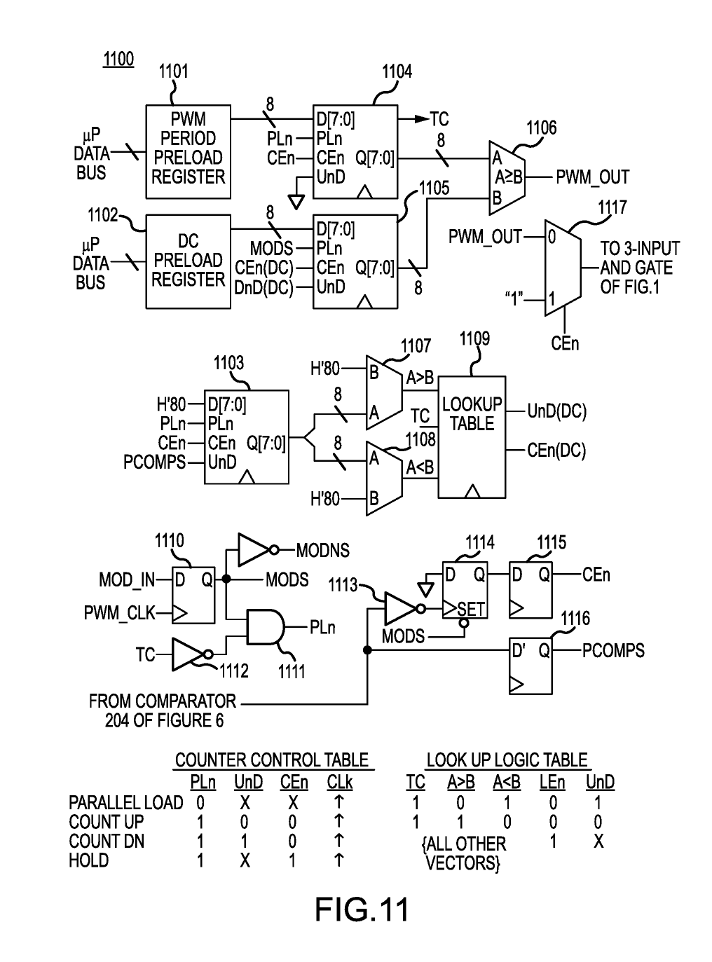

The effect on the laser output when temperature effects have reduced tube efficiency by 10% for example cause a laser transfer function change to Laser Output=0.9*(1−e^{-t/τ}) and can be simulated for illustration by using a DC register value that is too low by 10%. Holding everything equal except reducing the DC register value from value 55, as used in the simulation shown in FIGS. 7A-B, to value 50, results obtained are shown in FIG. 10. FIG. 10 is a plot 1002 of a third demonstrative simulation according to the disclosure. Ignoring error due to ripple effect, the pulse amplitude drops by 11% of the desired value during the 25 μs pulse width period. These results are similar to what is observed after CO₂ laser gas temperature has increased above its equilibrium, non-inverted temperature. Gas temperature increase is an unavoidable consequence of the plasma formation and population inversion process of a CO₂ laser and corrections that enable the pulse output properties to remain constant during long periods of laser operation during which internal temperatures are not constant is desirable. When such effects as temperature-induced efficiency change happen during a laser machining operation, laser output pulse reproducibility is improved by using active feedback to adjust PWM duty cycle continuously during delivery of each laser pulse. A PWM circuit realization that allows for this additional mode of operation is shown in FIG. 11, where additions have been made to a less-complex PWM realization that uses only a PWM period counter, a DC register, and a comparator to construct the PWM circuit 814 of FIG. 8.

FIG. 11 is a circuit diagram of an embodiment 1100 of the PWM circuit 814 of FIG. 8. In practice, a high-speed clock signal, set to 48 MHz for example, is used for the clock inputs of circuits 1103, 1104, 1105, 1109, 1110, 1115 and 1116 of FIG. 11. The microprocessor bus that is used to load the PWM period preload register 1101 and the duty cycle preload register 1102 is synchronized to the same high-speed clock signal. The modulation input signal, labeled MOD_In in FIG. 11, is synchronized to the high-speed clock signal, PWM_CLK, using the flip-flop 1110. The MODS signal output of the flip-flop 1110 is a synchronized version of the MOD_In signal. MODS is used as a control signal for various circuits of FIG. 11. For example, MODS is used to set the output of the flip-flop 1114 to digital-high and to force the output of the flip-flop 1115, CEn, digital-high whenever the MOD_In input is digital-low. MODS is also connected to the PLn input of the counter 1105. MODS causes the counter 1105 to preload the duty cycle preload register 1102 contents whenever MOD_In is digital-low.

Further, the flip-flop 1116 is used to generate a synchronous version of the output the first comparator 812 as shown in FIG. 8, PCOMPS. PCOMPS is used as the up/down counter direction control input for the counter 1103. The parallel load enable inputs, PLn, of the counters 1103, 1104, are connected to the signal PLn. The counters 1103, 1104 load the values present at their respective “D” inputs on the positive clock edge whenever PLn is digital-low. PLn is generated from the logical AND of the MODS signal and the inverse of the signal TC (see flip-flop 1110 in FIG. 11). The signal TC is also connected to the lookup table 1109. The lookup table 1109 uses the results of the counter 1103 and the signal TC to control the count enable input and count direction input of the counter 1105, signals CEn(DC) and UnD(DC), respectively. CEn(DC) and UnD(DC) are used to adjust the outputs of the counter 1105 based on counter 1103 contents on the next rising edge of PWM_CLK after TC goes digital-high whenever MODS is digital-high. The table in the lower left of FIG. 11 is a logic table for the counter 1103, and the table in the lower right of FIG. 11 is a logic table for the lookup table 1109. The output of the multiplexer 1117 is provided as input to the AND gate 816 shown in FIG. 8. The output of the multiplexer 1117 is equal to PWM_Out whenever CEn is digital-low and always digital-high whenever CEn is digital-high. Other embodiments are possible.

The counter 1104, the counter 1105, and the comparator 1106 are the three elements of a typical pulse-width modulator, the counter element, the duty cycle compare register element and the comparator element, respectively, similar to that discussed above in connection with at least FIGS. 6-8. The outputs of both the counter 1104 and the counter 1105 are the same number of bits wide, 8 bits in the present example. The counter 1104 counts up when CEn is low. Its preload value is the difference between the terminal value of counter 1105, 255 in this case, and the desired PWM output signal period in units of clock ticks. The counter 1104 is preloaded from PWM period preload register 1101 whenever the PLn signal is digital-low and a rising edge on the clock input of the counter 1104 occurs. The counter 1105 is preloaded from the duty cycle preload register 1102 only when MODS is low. The preload value of the counter 1105 is the difference between the terminal value of the counter 1104 and the desired value of the PWM_Out signal duty cycle in units of clock ticks. When the outputs of the counters 1104, 1105, respectively, equal their preload values, the output of the comparator 1106 is digital-low, shutting OFF the RFPS 104 (see FIG. 1) if CEn is digital-low. When PLn goes digital-high and CEn is digital-low, the counter 1104 begins counting up from its preload value towards its terminal count. When the output of the counter 1104 equals the output of the counter 1105, PWM_Out goes digital-high and the RFPS 104 is turned ON. Whenever TC goes digital-high and MODS is digital-high, PLn goes digital-low causing the PWM cycle to begin again from the counter 1104 preload value at the next PWM_CLK rising edge following TC going digital-high. Whenever CEn is digital-high, the output of the multiplexer 1117 goes digital-high to enable the RFPS 104 to turn ON when the next rising edge of MOD_In occurs.

The counter 1103, the comparator 1107, the comparator 1108, and the lookup table 1109 are used to adjust the duty cycle of PWM_Out once every cycle of the PWM_Out signal. When PLn is digital-low, the counter 1103 preloads to hexadecimal 80 (decimal 128) and begins counting when PLn goes digital-high and CEn is digital-low. PCOMPS causes the counter 1103 to count either up or down based on the state of PCOMPS. If the average value of the voltage signal 114 of the detector 112 during the time interval defined by the PWM cycle is exactly equal to V_{REF1} (see FIG. 1), then an equal number of up and down counts will occur during the PWM_Out signal period. In this case, the output of counter 1103 would be hexadecimal 80 when TC next goes digital-high and the lookup table 1109 sends CEn(DC) digital-high, leaving the duty cycle unchanged. On the other hand, if the average value of the voltage signal 114 of the detector 112 is either greater than V_{REF1}, or lower than V_{REF1}, then the value of the counter 1103 will not be hexadecimal 80 when TC next goes digital-high. In either of these cases, the lookup table 1109 uses CEn(DC) and UnD(DC) to adjust the duty cycle in the appropriate direction based on the contents of the output of the counter 1103. Further, during periods of time when the MOD_In signal is digital-low, the counters shown in FIG. 11 are all held in their preload states by PLn.

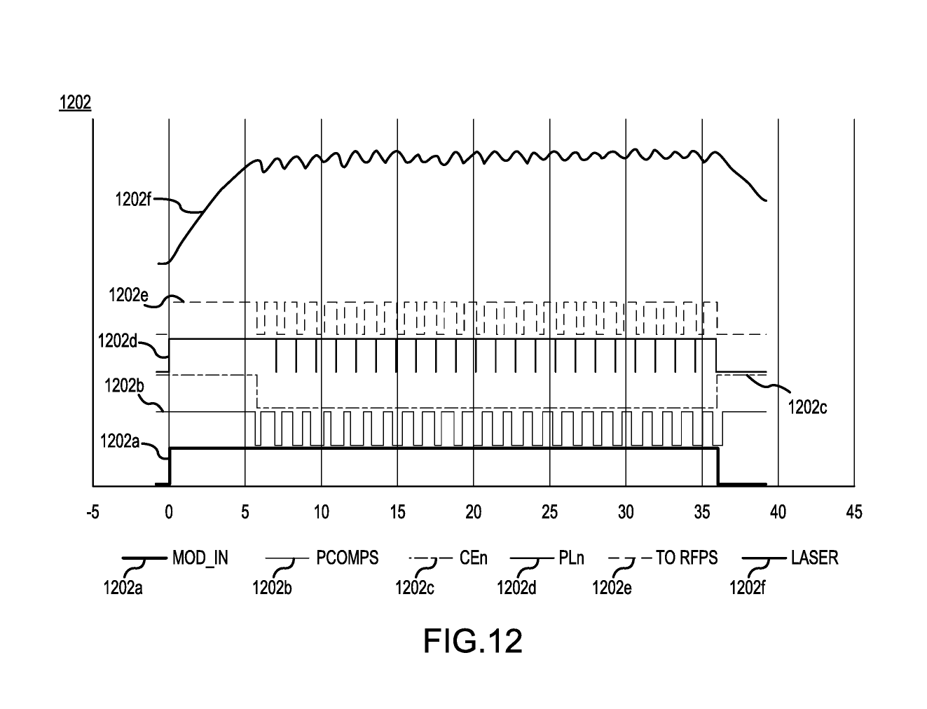

FIG. 12 is a timing diagram 1202 of sequential operation of the circuit of FIG. 11. Shown in the timing diagram is signal MOD_In 1202a, signal PCOMPS 1202b, signal CEn 1202c, signal PLn 1202d, signal 1202e that is provided to RFPS 104 (e.g., drive signal 120 as shown in FIG. 1), and a laser output single of the CO₂ laser 102 (e.g., laser pulse 110 as shown in FIG. 1). With additional reference to FIG. 1, FIG. 8, and FIG. 11, sequential operation of the circuits in FIG. 11 begins when MOD_In 1202a makes a digital-low to digital-high transition. When MOD_In 1202a is digital-low, PCOMPS 1202b is digital-high because the CO₂ laser 102 is OFF, CEn 1202c is digital-high, PLn 1202d is digital-low, and the signal to the AND gate 816 is digital-high. When the rising edge of MOD_in 1202a arrives at t=0, PLn 1202d and MODS both go digital-high leaving counters 1103, 1104, and 1105 preloaded. This state holds until the laser output rises to the power corresponding to the V_{REF1} input of the first comparator 812. At this point in time, PCOMPS 1202b goes digital-low, CEn 1202c goes digital-low, and the counter 1104 begins counting up. The output of the counter 1104 is less than the output of the counter 1105 so signal 1202e goes digital-low, shutting OFF the RFPS 104. When the counter 1104 reaches the value of the counter 1105, signal 1202e is returned to digital-high, turning back ON the RFPS 104. TC goes digital-high when the counter 1104 reaches its terminal value and starts the preload and counter restart events that will take signal 1202e back to digital-low. During the first and every full cycle of signal 1202e signal thereafter, the counter 1103 measures the average value of the laser power during the signal 1202e period and adjusts the duty cycle as needed before the next cycle begins. In some embodiments, this process continues until the MOD_In 1202a transitions digital-high to digital-low, returning the circuit of FIG. 11 to the initialization state as shown at t=36 μs in FIG. 11, and laser power begins to fall or decay to zero.

Yet another mode of operation of the circuit of FIG. 11 is contemplated whereby circuits 1103, 1107, 1108, and 1109 are not utilized and CEn of circuit 1105 is tied digital-high. In this mode, no ongoing adjustments of the duty cycle of signal 1202e are made after laser output (e.g., laser pulse 110) first reaches V_{REF1}. Here, the counter 1104 begins counting when CEn 1202c goes digital-low as described above, but the duty cycle of signal 1202e remains fixed at the value determined by the duty cycle preload register 1102. This mode can, for example, be used for short pulses where ongoing laser power control is not necessary because the pulse is soon terminated by the pulse energy control branch or circuit of the controller circuit 116 or by a falling edge on MOD_In 1202a.

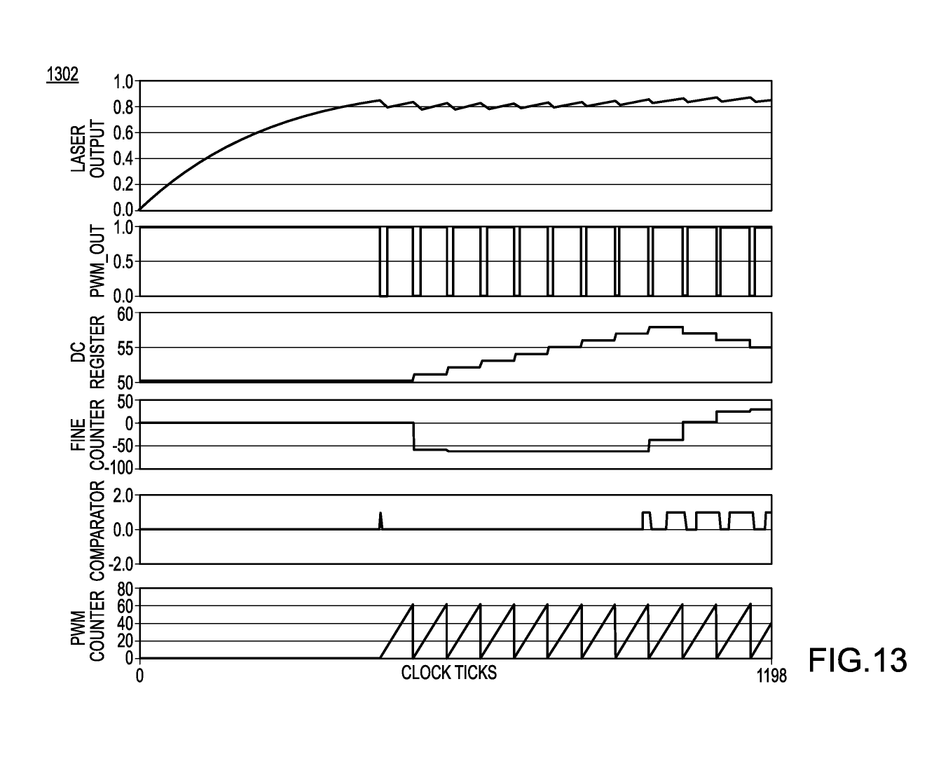

FIG. 13 is a plot 1302 of a fourth demonstrative simulation according to the disclosure. The simulation results shown in FIG. 13 are obtained when the PWM circuit 814 of FIG. 8 (and FIG. 11) is used and the DC register value is 10% lower than the actual value required. The peak-valley amplitude error ignoring the ripple effect is reduced from 11% to 6%, as compared to the data shown in plot 1002 of FIG. 10.

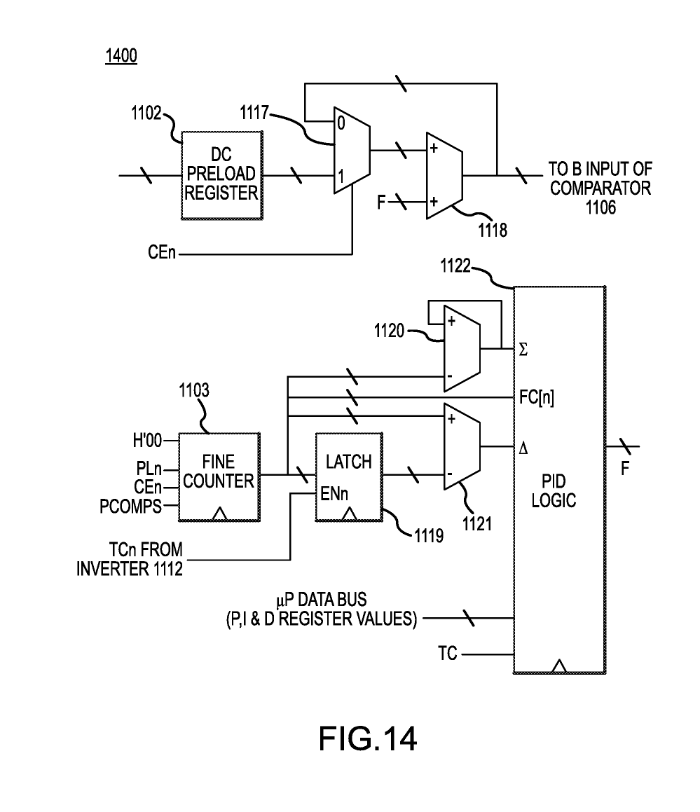

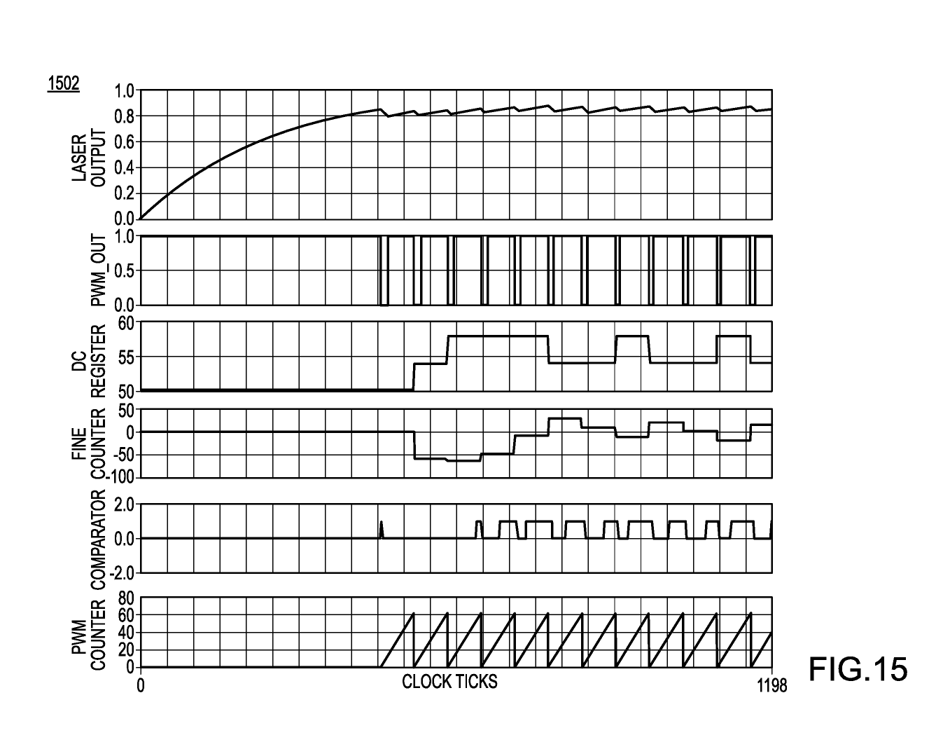

The circuit of FIG. 11 is, in effect, a proportional-integral-derivative (PID) controller with I=D=0 and with a limiter used to limit the duty cycle adjustments to one PWM compare register bit per PWM period. With additional registers, adders and combinatorial logic used to replace the counter 1105 and other elements of FIG. 11, it is contemplated that generalized PID control methods can be used to adjust the PWM compare value during delivery of laser output pulses. Example changes to the circuit shown in FIG. 11 are shown in FIG. 14. FIG. 14 is a circuit diagram that illustrates a modification to a portion of the circuit of FIG. 11. More specifically, a comparator 1118, a latch 1119, a comparator 1120, a comparator 1121, and a PID logic 1122 are shown as incorporated into the embodiment 1100 of the PWM circuit 814 as shown in FIG. 11. Using P=D=2 in the same simulation test case as in FIG. 13, the pulse amplitude error (once again ignoring the ripple term) reduces further to 3.5% as shown in FIG. 15.

FIG. 15 is a plot 1502 of a fifth demonstrative simulation according to the disclosure. In general, P, I, and D coefficients are implemented as host computer interface commands (see host computer interface 802 in FIG. 8) and corresponding memory mapped registers (see microprocessor 810 in FIG. 8). It is contemplated that these coefficients may be used to configure a further plurality of modes including an average power control mode that in effect can be used to generate arbitrarily long pulses of constant power, or intentionally varied power under control of the V_{REF1} control register value, with settling time determined mainly by the rise time of the laser itself, and start time controlled by the MOD_In signal. The modulation data path of the controller circuit 116 as shown in FIG. 8 therefore presents a common user interface and non-complex command set that can be used to generate arbitrarily long laser output pulses and operate over the entire operating domain of CO₂ lasers from the high-speed pulse regime to the pseudo continuous wave (CW) regime of RF pumped CO₂ lasers. Pseudo CW operation is obtained at controlled power levels using the modulation data path by sending the P command as mentioned above and a rising edge on the MOD_In signal with the pulse energy integrator disabled, or equivalently the pulse energy branch or circuit of the controller circuit 116 disabled. Depending upon the process type (e.g., cutting, annealing, etc.) optimum tradeoffs exist between the average power output and the degree of ripple which in some machining processes can be analogous to the selection of the number of teeth in a saw blade. Some processes produce superior results when average power and peak to average power ratio and pulse frequency are independent controls available to the user. This flexibility is optimized when both the PID coefficients and the PWM period register are controls that are made available to the machine tool designer and technician, in a manner as described. Higher or greater peak to average ratio can be achieved by deliberate lowering of the PWM period and by using appropriate PID coefficients.

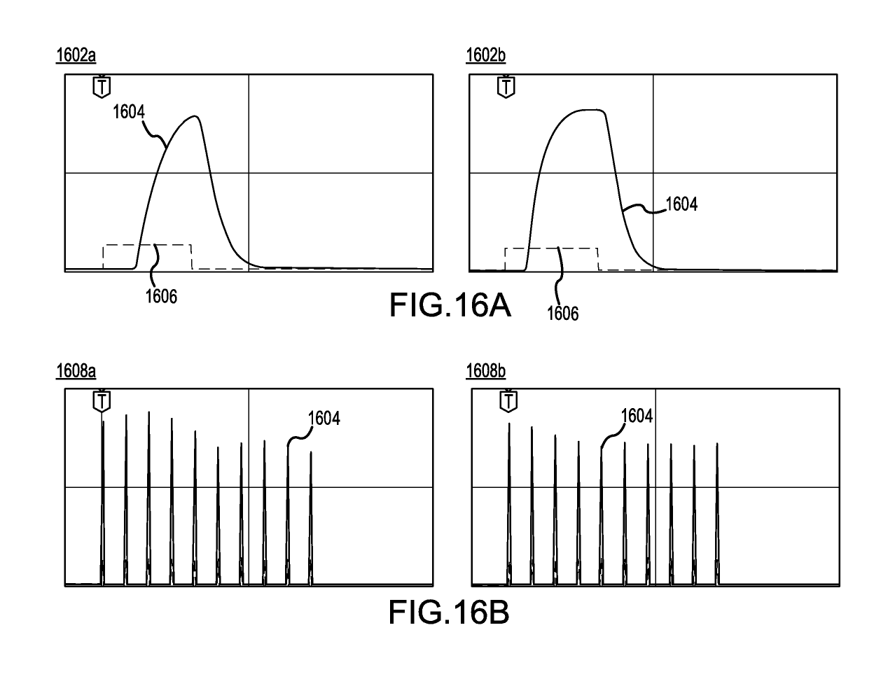

As mentioned above, detecting and notifying an operator or technician of degradations due to aging and other mechanisms is an object of the present disclosure. FIG. 16A is a first plot of the gas-dependent response of the apparatus of FIG. 1. FIG. 16B is a second plot of the gas-dependent response of the apparatus of FIG. 1. In particular, plot 1602a and plot 1602b as shown in FIG. 16A illustrate the laser response to a single 20 μs drive signal (e.g., drive signal 120) before (plot 1602a) and after (plot 1602b) a change in the gain medium or gas of the CO₂ laser 102. Similarly, plot 1608a and plot 1608b as shown in FIG. 16B illustrate a laser pulse train 1610, that is a sequence of 10 laser pulses each 20 μs in duration, output by the CO₂ laser 102 of the apparatus 100 of FIG. 1 in response to a command signal 1612 before (plot 1608a) and after (plot 1608b) a change in the gain medium or gas of the CO₂ laser 102. It is contemplated that the shape or form of a particular laser pulse or pulse train output the CO₂ laser 102 may be used as an indicator to determine when preventive maintenance should be performed. Automatically indicating when preventive maintenance should be performed is a valuable alternative to costly, unplanned laser machine tool downtime.

For example, as shown by plot 1602a and plot 1602b of FIG. 16A, the delay between the leading edge of the command signal 1606 and the leading edge of the laser pulse 1604 is reduced when the gain medium or gas of the CO₂ laser 102 is newly replaced or refreshed. It is contemplated that this delay may be utilized as a metric to determine when the gain medium or gas of the CO₂ laser 102 should be replaced. For example, using the delay as shown by plot 1602b as a baseline, when that delay has increased an amount corresponding to ½ or 50% the difference between the firing delay of plot 1602a and the firing delay of 1602b, a maintenance signal may be generated by the controller circuit 116 of FIG. 1 to automatically schedule a date/time for preventative maintenance of the CO₂ laser 102. However, it is contemplated that this “delay” criterion may be utilized alone or together with one or more other criterion to determine when preventive maintenance of the CO₂ laser 102 should be performed.

As another example, as shown by plot 1602a and plot 1602b of FIG. 16A, the rise time of the laser pulse 1604 is shortened when the gain medium or gas of the CO₂ laser 102 is newly replaced or refreshed. It is contemplated that this rise time may be utilized as a metric to determine when the gain medium or gas of the CO₂ laser 102 should be replaced. For example, using the rise time as shown by plot 1602b as a baseline, when that rise time has decreased to a value near but still less than a rise time that is known to be detrimental to the quality of a particular type of laser machine tool's performance, a maintenance signal may be generated by the controller circuit 116 of FIG. 1 to automatically schedule a date/time for preventative maintenance of the CO₂ laser 102. However, it is contemplated that this “rise time” criterion may be utilized alone or together with one or more other criterion to determine when preventive maintenance of the CO₂ laser 102 should be performed.

As yet another example, as shown by plot 1602a and plot 1602b of FIG. 16A, the amount of time that the laser pulse 1604 is at peak pulse power is lengthened when the gain medium or gas of the CO₂ laser 102 is newly replaced or refreshed. It is contemplated that this amount of time may be utilized as a metric to determine when the gain medium or gas of the CO₂ laser 102 should be replaced. For example, using the amount of time that the laser pulse 1604 is at peak pulse power as shown by plot 1602b as a baseline, when that amount of time has decreased to a value near but still more than an amount of time that is known to be detrimental to the quality of a particular type of laser machine tool's performance, a maintenance signal may be generated by the controller circuit 116 of FIG. 1 to automatically schedule a date/time for preventative maintenance of the CO₂ laser 102. However, it is contemplated that this “amount of time” criterion may be utilized alone or together with one or more other criterion to determine when preventive maintenance of the CO₂ laser 102 should be performed.

As yet another example, as shown by plot 1602a and plot 1602b of FIG. 16A, the fall time of the laser pulse 1604 is shortened when the gain medium or gas of the CO₂ laser 102 is newly replaced or refreshed. It is contemplated that this fall time may be utilized as a metric to determine when the gain medium or gas of the CO₂ laser 102 should be replaced. For example, using the fall time as shown by plot 1602b as a baseline, when that fall time has increased to a value near but still less than a fall time that is known to be detrimental to the quality of a particular type of laser machine tool's performance, a maintenance signal may be generated by the controller circuit 116 of FIG. 1 to automatically schedule a date/time for preventative maintenance of the CO₂ laser 102. However, it is contemplated that this “fall time” criterion may be utilized alone or together with one or more other criterion to determine when preventive maintenance of the CO₂ laser 102 should be performed.

As yet another example, as shown by plot 1602a and plot 1602b of FIG. 16A, the area under the curve of the laser pulse 1604, or equivalently the amount of energy delivered by the laser pulse 1604, is increased when the gain medium or gas of the CO₂ laser 102 is newly replaced or refreshed. It is contemplated that the area under the curve of the laser pulse 1604 may be utilized as a metric to determine when the gain medium or gas of the CO₂ laser 102 should be replaced. For example, using the area under the curve of the laser pulse 1604 as shown by plot 1602b as a baseline, when that area has decreased by a predetermined amount, a maintenance signal may be generated by the controller circuit 116 of FIG. 1 to automatically schedule a date/time for preventative maintenance of the CO₂ laser 102. However, it is contemplated that this “area under the curve” criterion may be utilized alone or together with one or more other criterion to determine when preventive maintenance of the CO₂ laser 102 should be performed.

In certain applications it may be desirable to use the command signal 118, or equivalent the Mod_In signal, to communicate target values of pulse parameters, such as pulse energy, on a pulse-to-pulse basis. Traditionally, CO₂ laser machine tools use width of a signal similar to the command signal 118 to adjust pulse energy to optimal values by using trial and error methods. The pulse parameters circuit 604 may provide the advantages of simultaneous pulse energy control and instantaneous power control as discussed throughout that is optimized for back-compatibility with machine tools that use the pulse width of the command signal to control the laser output. Specifically, the pulse parameters circuit 604 may allow instantaneous pulse power and pulse timing to be controlled as described above, but, pulse-to-pulse energy can be communicated using the pulse width of the command signal 118 as follows.

The pulse parameters circuit 604 is inserted into the path of the command signal 118 as shown in FIG. 6. The command signal 118 is not passed to the AND gate 216 for this optional mode of operation but is instead replaced by a pulse of predetermined width, Ttimer, which is discussed in further detail below. In practice, the predetermined width of the pulse Ttimer is controlled by writes from the microprocessor 810 of FIG. 8 and is longer in duration than an expected width necessary to allow a laser pulse to reach the desired pulse energy value. A timer circuit 1701 as shown in FIG. 17 generates this pulse using the synchronized command signal, MODS, which is generated by the flip-flop 1110 of FIG. 11, and the PWM_CLK clock signal. The purpose of the pulse parameters circuit 604 is to transfer pulse-to-pulse energy target values directly from pulse width encoded energy commands. For example, a pulse width of 5 μs can be used to correspond to a full scale pulse energy value of 100 mJ (e.g., desired pulse energy=100 mJ*PW[μs]/5[μs]). The choice of a relatively low full scale value such as 5 μs allows for a user to communicate the desired pulse width in time to set up the control circuits on a pulse by pulse basis while still allowing for short pulse periods necessary for high throughput. An example implementation of the pulse parameters circuit 604 is discussed in connection with FIG. 17.

FIG. 17 is a circuit diagram of an embodiment 1700 of the pulse parameters circuit 604 of FIG. 6. The synchronized command signal, MODS, as discussed above is used to control the timer circuit 1701, a time interval counter 1702 (whereby the Q output of a flip-flop 1705 is provided as input to the interval counter 1702), and a falling edge detector 1704. The falling edge detector 1704 causes the value of the time interval counter 1702 to be latched when the time interval counter 1702 has finished counting the number of PWM_CLK periods in the pulse width of the command signal 118. System-on-chip devices such as PSoC5LP have DMA controllers that share the data bus with the microprocessor and arbitrate traffic on the bus. It is contemplated that PS005LP DMA transfers can be designed to initiate transfer from a memory mapped register whenever contents of the memory mapped register are updated. The DMA transfer destination can be designated as another memory mapped register, such as the register used by the microprocessor 810 as shown in FIG. 8 to control the comparator reference voltage V_{REF2} as shown in FIG. 6. The DMA transfer can typically occur with less than 1 μs delay and with less than 1 μs uncertainty using commonly available clock speeds and by programming the DMA controller to give higher priority to register-to-register transfers over routine microprocessor traffic.

The PWM_CLK frequency and full scale Command Signal pulse width determine the size of the counter. For example, with 5 μs corresponding to full scale pulse energy and a 48 MHz clock an 8 bit counter may be leveraged as shown by Equation 3:

$$N bits \geq \frac{ln ( \begin{matrix}Command Signal Pulse Width , \\ max [ uSec ] \times PWM\_CLK Frequency [ Hz ]\end{matrix} )}{ln 2} = 7.96 \qquad ( 3 )$$

In practice, the sequence of operation provided by the controller circuit 116 of the present disclosure and the pulse parameters circuit 604 may include or comprise the following steps: (1) a rising edge of the command signal 118 turns ON the RFPS 104; (2) the trailing or falling edge of the of the command signal 118 transfers a command pulse width measurement in units of PWM_CLK periods to a register; (3) the register update initiates a transfer of the command signal pulse width value to the memory mapped register that controls the DAC used to set the V_{REF2} signal (see FIG. 6). Since (1)-(3) may be completed before a laser pulse output by the CO₂ laser 102 starts or begins to rise, as in most cases the CO₂ laser 102 will not lase sooner than 5 μs after the start of an RF amplitude pulse provided by the RFPS 104, each new pulse energy target value is present at the input to the second comparator 212 (see FIG. 6) before the second comparator 212 activates the second flip-flop 214 to clock a digital-low thus causing the AND gate 216 terminate supply of the drive signal 120. The pulse parameters circuit 604 prevents the user from communicating expected pulse duration using the falling edge of the command signal 118. The signal path for communicating this value is through the microprocessor 810 of FIG. 8 to the timer circuit 1701 of FIG. 17 and the non-complex method of detecting when the CO₂ laser 102 fails to output the target pulse energy within an expected time interval as previously described is preserved. Alternatively, in the same manner as described above for using pulse width of the command signal to communicate pulse energy on a pulse-by-pulse basis, the same method can be used to communicate pulse instantaneous power. In this alternative, different pulse scaling is used to represent power and the destination of DMA transfers is changed from the register controlling V_{REF2} to the register controlling V_{REF1}. Pulse energy is communicated using the microprocessor.

An appreciation of the benefits and/or advantages that flow from the disclosed control scheme for simultaneously monitoring peak pulse power and pulse energy during the delivery of a laser pulse may be gained from the foregoing discussion in connection with the drawings. For example, the controller circuit 116 of the present disclosure may rapidly acquire optimized laser control algorithms or recipes, and significantly reduce trial and error time, reduce or eliminate scrap, and accelerate time-to-market of new machine control recipes and new laser-based material machining systems. These material processing modes include drilling holes, cutting, scribing, shaping and annealing, all of which may require reproducible laser pulse power, pulse energy, pulse shape, and pulse timing from machine to machine and from moment to moment. Further, the controller circuit 116 of the present disclosure may enable laser operating modes spanning the pulsed operation domain, about 10 μs to 1000 μs pulse width for example, all the way to the pseudo continuous wave domain are within the operating range of the laser apparatus as discussed above. Further, these laser operating modes can be mixed and changed from one to another on-the-fly and continuously such that a profile of laser output versus time can be arbitrarily and easily specified by the user operator and synchronized to the material processing machine state.

Further, the controller circuit 116 of the present disclosure may enable reproducible sequences of pulses: during changing thermal states of a gas-discharge laser; during systematic variation of the processing machine itself, i.e., variation of machine components that are external to the gas-discharge laser; and work piece characteristics that vary in a systematic and reproducible way during machine operation. Further, the controller circuit 116 of the present disclosure may enable a laser control user interface that is based on a natural, non-complex pulse property description language using minimal, custom hardwired control signals. Further, the controller circuit 116 of the present disclosure may automatically adjust for laser aging mechanisms which change the transfer function that relates the output pulse properties to the laser control input. Such aging mechanisms can, for example, require periodic procedures to adjust for reduced laser output power efficiency. Such procedures can be costly in terms of machine downtime, which becomes more costly still when such procedures are not performed on a regular basis. Costs in the form of unplanned machine downtime and scrap can quickly exceed the costs of preventative maintenance procedures made easier by the methods explained in this disclosure. Further, the controller circuit 116 of the present disclosure may automatically detect when laser aging conditions are such as to require periodic preventive maintenance procedures and notify the user when such procedures are required in advance so as to prevent sudden or unscheduled machine downtime.

Although only certain exemplary embodiments have been described in detail above, those skilled in the art will readily appreciate that many modifications are possible in the exemplary embodiments without materially departing from the novel teachings and advantages of this disclosure. Aspects of embodiments disclosed above can be combined in other combinations to form additional embodiments. All such modifications are intended to be included within the scope of this technology.

What is claimed is:

1. A gas-discharge laser system, comprising:
a gas-discharge laser;
a RF (Radio Frequency) power supply coupled to the gas-discharge laser and configured to energize the gas-discharge laser based on a drive signal;
a detector configured to sample a laser pulse output by the gas-discharge laser and generate a detection signal representative of the instantaneous power of the laser pulse;
a beam-splitter configured to supply a sample of the laser pulse to the detector; and
a controller coupled to the detector, the controller comprising:
an energy control circuit configured to monitor accumulated energy of the laser pulse as output by the gas-discharge laser and based on the detection signal, the energy control circuit configured to output an energy signal to indicate when accumulated energy of the laser pulse has reached an energy threshold;
a power control circuit configured to output a modulation signal based on a target instantaneous power for the laser pulse and the detection signal; and
a drive control circuit coupled to the energy control circuit and the power control circuit, the drive control circuit configured to output the drive signal, wherein the drive control circuit is configured to modulate the drive signal based on the modulation signal when the energy signal indicates that accumulated energy is less than the energy threshold and turn off the drive signal when the energy signal indicates that accumulated energy is greater than the energy threshold.

2. The system of claim 1, wherein the drive control circuit is configured to receive a command signal that indicates when the drive control circuit is to start modulating the drive signal.

3. The system of claim 2, wherein the controller is configured to output an error signal or a maintenance signal if accumulated energy is less than the energy threshold when a time period indicated by the command signal ends.

4. The system of claim 1, wherein the controller is configured to output a laser pulse parameter, and an error signal or a maintenance signal when the laser pulse parameter is outside of compliance.

5. The system of claim 1, wherein the power control circuit is configured to output the modulation signal so that instantaneous pulse power of the laser pulse is maintained within 10% of the target instantaneous power.

6. The system of claim 1, wherein the power control circuit is configured to output the modulation signal at a frequency selected from a range between 250 kHz and 750 kHz inclusive, wherein instantaneous pulse power of the laser pulse fluctuates in a range of values around the target instantaneous power, wherein the magnitude of the range of values is inversely proportional to the frequency.

7. A controller for a laser, comprising:
an energy control circuit configured to monitor accumulated energy of a laser pulse as output by the laser and based on a detection signal representative of instantaneous power for the laser pulse, the energy control circuit configured to output an energy signal to indicate when accumulated energy of the laser pulse has reached an energy threshold;
a power control circuit configured to output a modulation signal based on a target instantaneous power for the laser pulse and the detection signal; and
a drive control circuit coupled to the energy control circuit and the power control circuit, the drive control circuit configured to output a drive signal for the laser, wherein the drive control circuit is configured to modulate the drive signal based on the modulation signal when the energy signal indicates that accumulated energy is less than the energy threshold and turn off the drive signal when the energy signal indicates that accumulated energy has reached the energy threshold.

8. The controller of claim 7, wherein the drive control circuit is configured to receive a command signal that indicates when the drive control circuit is to start modulating the drive signal.

9. The controller of claim 8, wherein the controller is configured to output an error signal or a maintenance signal if accumulated energy is less than the energy threshold when a time period indicated by the command signal ends.

10. The controller of claim 7, wherein the controller is configured to output a laser pulse parameter, and an error signal or a maintenance signal when the laser pulse parameter is outside of compliance.

11. A method for operating a gas-discharge laser, comprising:
detecting a command to initiate output of a laser pulse by the gas-discharge laser;
in response to detecting the command, supplying a signal to the gas-discharge laser to initiate output of the laser pulse by the gas-discharge laser;
monitoring accumulated pulse energy of the laser pulse as output by the gas-discharge laser;
during the monitoring, modulating the signal supplied to the gas-discharge laser based on a target instantaneous pulse power for the laser pulse; and
terminating the signal supplied to the gas-discharge laser in response to determining that accumulated pulse energy of the laser pulse as output by the gas-discharge laser has reached an energy threshold value.

12. The method of claim 11, wherein modulating the signal supplied to the gas-discharge laser includes modulating the signal so that instantaneous pulse power of the laser pulse is maintained within 10% of the target instantaneous pulse power.

13. The method of claim 11, further comprising:
determining a time delay between a leading edge of a command signal that is associated with the command and a rising edge of the laser pulse; and
in response to determining that the time delay is greater than or equal to a predefined value, outputting an error signal or a maintenance signal.

14. The method of claim 11, further comprising:
measuring a pulse parameter of the laser pulse; and
in response to determining that the pulse parameter is outside of a limit for the pulse parameter, outputting an error signal or a maintenance signal.

15. The method of claim 14, wherein the pulse parameter is a fall time of the laser pulse, a rise time of the laser pulse, an amount of time for instantaneous pulse power of the laser pulse to reach a threshold value, or an amount of time for accumulated pulse energy of the laser pulse to reach the energy threshold value.

16. The method of claim 11, further comprising:
modulating the signal at a frequency selected from a range between 250 kHz and 750 kHz inclusive, wherein instantaneous pulse power of the laser pulse fluctuates in a range of values around the target instantaneous pulse power, wherein the magnitude of the range of values is inversely proportional to the frequency.

17. The method of claim 11, further comprising:
loading a first parameter profile for the laser pulse, wherein modulating the signal is based on at least one pulse parameter from the first parameter profile.

18. The method of claim 11, further comprising:
measuring a plurality of parameters that describe the shape or form of the laser pulse; and
recording the plurality of measured parameters, wherein the recorded plurality of measured parameters include an indication identifying the laser pulse.

19. The method of claim 11, wherein modulating the signal includes modulating the signal at a duty cycle based on instant thermal properties of the gas-discharge laser.

20. The method of claim 11, further comprising:
calculating a plurality of pulse width modulation values each based on a calibration value associated with the gas-discharge laser and a unique peak pulse power and pulse energy threshold value pair;
storing the plurality of pulse width modulation values in an array; and
generating the laser pulse by modulating the signal according to a particular one of the plurality of pulse width modulation values.

21. The method of claim 11, further comprising:
terminating the signal in response to detecting a command to stop output of the laser pulse.

22. The method of claim 11, further comprising:
in response to determining that accumulated pulse energy of the laser pulse as output by the gas-discharge laser has not reached the energy threshold value before terminating the signal, outputting an error signal or a maintenance signal.
